(19) United States
(12) Patent Application Publication
(10) Pub. No.: US 2021/0362572 A1
(43) Pub. Date: Nov. 25, 2021

(54) DRIVE APPARATUS FOR A MOVABLE ROOF PART OF A ROOF SYSTEM, AND THREADED HELIX CABLE FOR SUCH A DRIVE APPARATUS

(71) Applicant: BOS GmbH & Co. KG, Ostfildern (DE)

(72) Inventors: Michael HEIDAN, Stuttgart (DE); Marius MARQUART, Ostfildern (DE)

(21) Appl. No.: 17/311,110

(22) PCT Filed: Nov. 28, 2019
(86) PCT No.: PCT/EP2019/082831

§ 371 Date: Jun. 4, 2021

(30) Foreign Application Priority Data
Dec. 6, 2018 (DE) 102018221080.2
Feb. 15, 2019 (DE) 202019100862.8

(51) Int. Cl. B60J 7/057; F16C 1/16; F16C 1/20

(52) U.S. Cl. CPC B60J 7/0573; F16C 1/205; F16C 1/16

(57) ABSTRACT

A drive apparatus for a movable roof part of a roof system, and a threaded helix cable therefor. The drive apparatus has a threaded helix cable, which has a driver on the end, by which the threaded helix cable can be connected to a drive slide of a displacement mechanism in a force-transmitting manner. The driver has a bent sheet-metal part which interlockingly surrounds the threaded helix cable.

The invention relates to a drive device for a movable roof part of a roof system, having a thread-pitch cable which has at an end side a driver by means of which the thread-pitch cable can be connected in a force-transmitting manner to a drive slide of a transfer mechanism. The invention also relates to a thread-pitch cable for a drive device of said type.

WO 2017/157655 A1 has disclosed a thread-pitch cable for a drive device of a movable roof part of a roof system. The thread-pitch cable is connected at one side to a driver which is designed as a free-falling plastic injection-molding part. The driver is provided with an inner thread which can be screwed onto outer windings of the thread-pitch cable. Additionally, after the screwing-on, the driver is fixed in a materially bonded manner, preferably by adhesion, fusion or welding, to the thread-pitch cable. For the purpose of increasing its stability, the driver may be provided with a sheet-metal inlay which is encapsulated by the plastic of the plastic injection-molding part.

WO 2017/153103 A1 has disclosed a further thread-pitch cable for a drive device of a roof system, in which the thread-pitch cable is modified at an end side in that the outer windings are removed in order to expose an inner steel core. The steel core is injected into a driver consisting of plastic in order to achieve the fixed connection between the driver and the thread-pitch cable.

It is an object of the invention to provide a drive device and a thread-pitch cable of the type mentioned at the beginning that ensure a reliable drive transmission function in relation to a drive slide of a transfer mechanism.

Said object is achieved for the drive device and for the thread-pitch cable in that the driver has a sheet-metal bending part which surrounds the thread-pitch cable in a form-fitting manner. The sheet-metal bending part is preferably produced as a steel sheet. Alternatively, the sheet-metal bending part may also be produced from a formable light metal alloy. The form-fitting surrounding of the thread-pitch cable by the sheet-metal bending part is realized by cold-forming. The form fit is achieved both radially with respect to a longitudinal axis of the thread-pitch cable and axially with respect to said longitudinal axis.

In one configuration of the invention, the sheet-metal bending part has multiple mutually parallel receiving slots whose dimensions are configured in a manner complementary to outer windings of the thread-pitch cable. The receiving slots are formed in such a way that the outer windings of the thread-pitch cable penetrate into said slots, which results in the desired form fit between the sheet-metal bending part and the thread-pitch cable.

In one configuration of the invention, the sheet-metal bending part has thread-like inner profilings which are formed in a manner complementary to outer windings of the thread-pitch cable. The thread-like inner profilings of the sheet-metal bending part advantageously arise during cold-forming of the sheet-metal bending part around the thread-pitch cable, in that the corresponding outer windings of the thread-pitch cable are stamped into the sheet-metal bending part. The sheet-metal bending part is bent under pressure around the thread-pitch cable in such a way that the sheet-metal material of the sheet-metal bending part is deformed plastically, in particular by pressing or squeezing, in the region of the outer windings.

In a further configuration of the invention, the sheet-metal bending part is of plate-like form and is folded around the thread-pitch cable in such a way that two tab portions in areal abutment with one another are produced laterally next to the thread-pitch cable. The tab portions in areal abutment with one another laterally next to the thread-pitch cable are connected to the drive slide during later operation of the drive device, with the result that said tab portions perform the driver function of the driver.

In a further configuration of the invention, the sheet-metal bending part is wrapped in a form-fitting manner around the outer windings of the thread-pitch cable by cold-forming, in particular by a squeezing process, so as to form the receiving slots or inner profilings. The material thickness of the sheet-metal bending part is selected in such a way that, during a corresponding cold-forming process, in the region of the outer windings of the thread-pitch cable, the desired plastic deformation of that portion of the sheet-metal bending part which is curved around the thread-pitch cable is obtained, with the inner profilings being achieved.

In a further configuration of the invention, the sheet-metal bending part is surrounded, in particular encapsulated, by a plastic body which can be connected in a form-fitting manner to the drive slide. In this configuration, the sheet-metal bending part has a dual function in that it serves both for stiffening the plastic body and for form-fitting connection of the plastic body to the thread-pitch cable. The form-fitting connection to the drive slide means that the plastic body is driven in a form-fitting manner in the travel direction of the drive slide.

In a further configuration of the invention, the sheet-metal bending part has a connection portion which is spaced apart laterally from the thread-pitch cable and which can be connected in a form-fitting manner to the drive slide. The laterally spaced-apart connection portion is achieved in particular by the two above-described tab portions in areal abutment with one another. The connection portion is matched to a receiving region of the drive slide in such a way that the connection portion can be inserted in a complementary manner and without play into the receiving region in order to achieve reliable drive transmission of the linear movement of the thread-pitch cable to the drive slide.

Further advantages and features of the invention emerge from the claims and from the following description of a preferred exemplary embodiment of the invention, which is presented on the basis of the drawings.

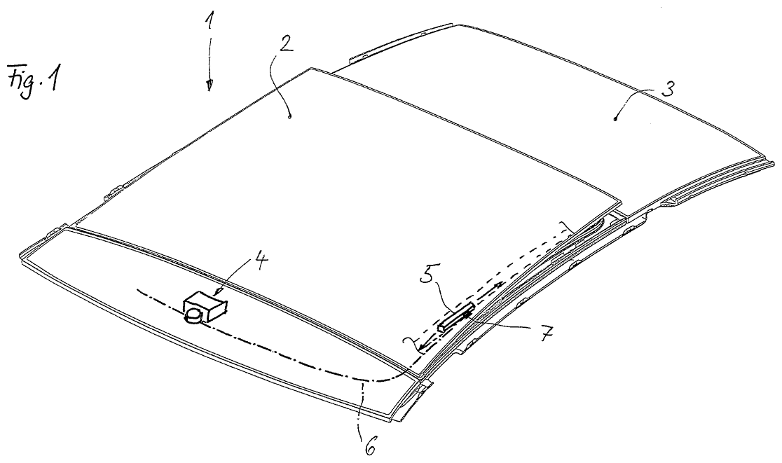

FIG. 1 shows a roof system for a passenger motor vehicle with an embodiment of a drive device according to the invention,

FIG. 2 shows, in a plan view, a sub-region of an embodiment of a thread-pitch cable according to the invention for the drive device as per FIG. 1,

FIG. 3 shows, in a side view, the thread-pitch cable as per FIG. 2,

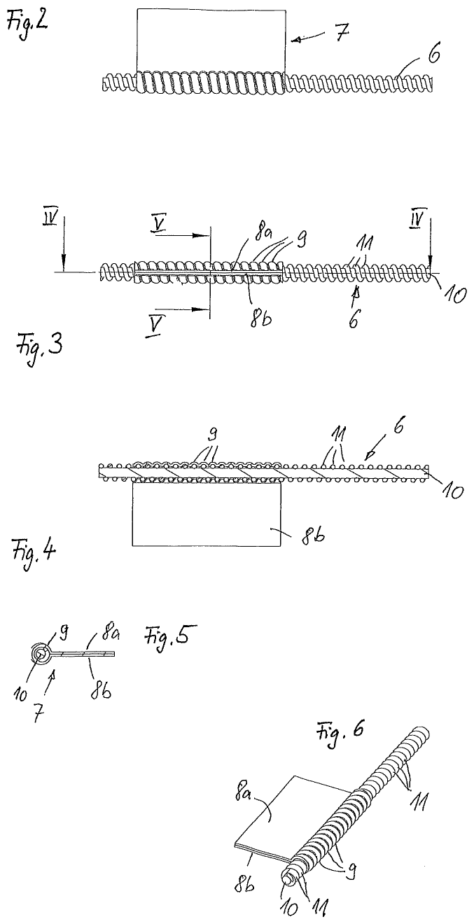

FIG. 4 shows the thread-pitch cable as per FIG. 3 in a longitudinal sectional illustration along the section line IV-IV in FIG. 3,

FIG. 5 shows a cross-sectional illustration along the section line V-V from FIG. 3,

FIG. 6 shows a three-dimensional illustration of the thread-pitch cable as per FIGS. 2 to 5,

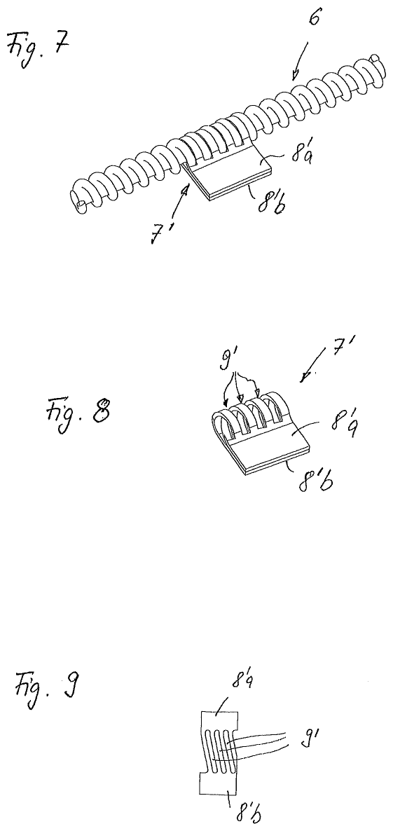

FIG. 7 shows, in a perspective view, a sub-region of a further embodiment of a thread-pitch cable according to the invention for the drive device as per FIG. 1,

FIG. 8 shows a driver, formed as a sheet-metal bending part, for the thread-pitch cable as per FIG. 7, and

FIG. 9 shows the sheet-metal bending part as per FIG. 8 in a plate-like form, that is to say before a forming process leading to the form as per FIG. 8.

A passenger motor vehicle has in a roof region a roof system 1 which comprises a frame which is mounted fixedly in a roof cutout of the roof region of a vehicle body of the passenger motor vehicle. The roof system 1 is provided with a movable front roof part 2 and a fixed rear roof part 3. For the transfer of the roof part 2 between a closed position, a venting position (illustrated in FIG. 1) and an open position, a transfer mechanism driven by means of a drive device is provided. FIG. 1 schematically illustrates a drive slide 5 of the transfer mechanism, which drive slide can be displaced in a linearly movable manner in the vehicle longitudinal direction in a guide rail (indicated by dashed lines) of the frame of the roof system 1. In order to be able to move the drive slide 5 in the longitudinal direction of the guide rail, provision is made of a drive transmission means in the form of a thread-pitch cable 6 (illustrated by a chain-dotted line), which is connected at an end side to the drive slide 5 by means of a driver 7. The thread-pitch cable 6 is guided in a linearly movable manner and is driven by a drive motor 4 and an associated transmission in opposing directions. Merely one drive side is illustrated from FIG. 1. An opposite drive side for the movable roof part 2 is provided in the same way with a transfer mechanism, with a drive slide and with a further thread-pitch cable, wherein the opposite drive sides are operated by the drive device in a manner synchronized with respect to one another.

A transmission of the drive force of the drive motor 4 from the thread-pitch cable 6 to the drive slide 5 is realized via the driver 7. For this purpose, the driver 7 has a connection portion which projects inward transversely with respect to a longitudinal axis of the thread-pitch cable 6 and which, as per FIG. 2, projects upward in the plane of the drawing and is of rectangular basic form. It can be seen from FIG. 6 that the connection portion has a plate-like form in the manner of a cuboid. The drive slide 5 has a complementary receiving region into which the connection portion of the driver 7 penetrates without play, so as to achieve the driving of the drive slide 5 during a corresponding linear movement of the thread-pitch cable 6.

As can be seen from FIGS. 2 to 5, the thread-pitch cable has a substantially cylindrical core 10, said core being in the form of a steel cable. Outer windings 11 of a further wire cable are spiralled around the core 10 and are connected fixedly to the core 10. The transmission of the drive motor 4 engages around the outer windings 11 by means of a worm. Rotation of the worm inevitably leads to the desired linear movement of the thread-pitch cable 6. FIGS. 2 to 6 illustrate an end region of the thread-pitch cable 6, on which end region the driver 7 is arranged. The driver 7 is formed by a sheet-metal bending part consisting of a thin-walled steel sheet. The steel sheet is of plate-like form and is wrapped in a form-fitting manner around the periphery of the thread-pitch cable 6 so as to form two tab portions 8a and 8b, which project laterally, that is to say transversely, from the thread-pitch cable 11. The sheet-metal bending part is additionally pressed onto the thread-pitch cable 6, in the present case by a squeezing process. In this way, those regions of the sheet-metal bending part which surround the thread-pitch cable 6 are stamped from the outside into the outer windings 11 of the thread-pitch cable 6. At the same time, the tab portions 8a and 8b come into areal abutment with one another. The squeezing process results in there being formed on the sheet-metal bending part inner profilings 9, which are formed in a manner complementary to the outer windings 11 of the thread-pitch cable 6 and thus penetrate between the outer windings 11. In this way, an additional form fit in the axial direction of the thread-pitch cable 6 is achieved. It can be clearly seen from FIGS. 2 to 6 that the outer windings 11 have been pressed into the sheet material of the sheet-metal bending part. It can moreover be seen from FIGS. 5 and 6 that the two laterally projecting tab portions 8a and 8b are in areal abutment with one another over their entire base surface. In the illustration as per FIGS. 2 to 6, the sheet-metal bending part has been deformed plastically, and so the illustrated deformation is permanent.

In one exemplary embodiment (not illustrated), the sheet-metal bending part as per FIGS. 2 to 6 is additionally encapsulated by a plastic body. Here, the encapsulation is realized only after the sheet-metal bending part has been fastened to the thread-pitch cable 11. This means that the thread-pitch cable 6 is placed into an injection-molding tool with the sheet-metal bending part as per FIGS. 2 to 6 in the illustrated cold-formed version and, subsequently, the sheet-metal bending part is encapsulated with plastic.

The embodiment as per FIGS. 7 to 9 is used in the same way as the embodiment as per FIGS. 2 to 6, specifically with a drive device as per FIG. 1. The sole difference in the case of the thread-pitch cable as per FIGS. 7 to 9 is that the driver 7′ is formed slightly differently than the driver 7 as per FIGS. 2 to 6. Functionally identical portions of the driver 7′ are denoted by the same reference signs as those in the case of the driver 7, with a prime ‘ added. The driver 7’, analogously to the above-described driver 7, is also formed as a sheet-metal bending part. The essential difference is that the form-fitting engagement around the outer windings of the thread-pitch cable 6 is realized in that the sheet-metal bending part as per FIGS. 7 to 9 has three mutually parallel receiving slots 9′, which are oriented obliquely in a manner complementary to a pitch of the outer windings of the thread-pitch cable 6. In terms of their width and in terms of their length, the receiving slots 9′ are matched to the outer windings of the thread-pitch cable 6 in such a way that in each case one outer winding can penetrate into in each case one receiving slot 9′ (visible from FIG. 7). Also, the webs, flanking the receiving slots 9′, of the sheet-metal bending part are matched to the spacings of the outer windings of the thread-pitch cable 6 to one another, whereby, when the sheet-metal bending part is wrapped around the outer windings of the thread-pitch cable 6, the outer windings penetrate into the receiving slots 9′ and the flanking webs are placed into an intermediate space between two adjacent outer windings in each case.

With regard to the tab portions 8′a and 8′b and also with regard to the forming of the sheet-metal bending part around the thread-pitch cable 6, the embodiment as per FIGS. 7 to 9 corresponds to the embodiment described above on the basis of FIGS. 2 to 6. Therefore, to avoid repetitions, reference is made to the statements concerning the embodiment as per FIGS. 2 to 6.

The sheet-metal bending part which forms the driver 7′ as per FIGS. 7 to 9 is punched out of a planar sheet-metal plate, or cut out in some other manner, according to the cut and the contours, these being visible from FIG. 9.

The advantage of the embodiment as per FIGS. 7 to 9 over the embodiment described above on the basis of FIGS. 2 to 6 is that the sheet-metal bending part of the driver 7′ can be bent around the outer periphery of the thread-pitch cable 6 without a relatively great application of force. This is because, by contrast to the embodiment as per FIGS. 2 to 6, in which, by way of corresponding pressure action owing to the stamping process, the outer windings are stamped into the sheet metal of the sheet-metal bending part, in the embodiment as per FIGS. 7 to 9, the corresponding receiving slots 9′ and the interposed webs, with respect to outer windings and intermediate spaces of the thread-pitch cable 6, inevitably slide one into the other in a form-fitting manner without the necessity of a complex pressing process, which could lead to a deformation of the outer windings of the thread-pitch cable 6.

1. A drive device for a movable roof part of a roof system, having a thread-pitch cable which has at an end side a driver by which the thread-pitch cable can be connected in a force-transmitting manner to a drive slide of a transfer mechanism, wherein the driver has a sheet-metal bending part which surrounds the thread-pitch cable in a form-fitting manner.

2. The drive device as claimed in claim 1, wherein the sheet-metal bending part has multiple mutually parallel receiving slots whose dimensions are configured in a manner complementary to outer windings of the thread-pitch cable.

3. The drive device as claimed in claim 1, wherein the sheet-metal bending part has thread-like inner profilings which are formed in a manner complementary to outer windings of the thread-pitch cable.

4. The drive device as claimed in claim 1, wherein the sheet-metal bending part is of plate-like form and is folded around the thread-pitch cable such that two tab portions in areal abutment with one another are produced laterally next to the thread-pitch cable.

5. The drive device as claimed in claim 1, wherein the sheet-metal bending part is wrapped in a form-fitting manner around outer windings of the thread-pitch cable by cold-forming, or a cold-forming squeezing process, so as to form receiving slots or inner profilings.

6. The drive device as claimed in claim 1, wherein the sheet-metal bending part is surrounded, or is encapsulated, by a plastic body which can be connected in a form-fitting manner to the drive slide.

7. The drive device as claimed in claim 1, wherein the sheet-metal bending part has a connection portion which is spaced apart laterally from the thread-pitch cable and which can be connected in a form-fitting manner to the drive slide.

8. A thread-pitch cable for a drive device for a movable roof part of a roof system, the thread-pitch cable comprising a driver which is arranged at an end side of the thread-pitch cable, the thread-pitch cable being connectable by the driver in a force-transmitting manner to a drive slide of a transfer mechanism, wherein the driver has a sheet-metal bending part which surrounds the thread-pitch cable in a form-fitting manner.

9. The thread-pitch cable as claimed in claim 8, wherein the sheet-metal bending part has multiple mutually parallel receiving slots whose dimensions are configured in a manner complementary to outer windings of the thread-pitch cable.

10. The thread-pitch cable as claimed in claim 8, wherein the sheet-metal bending part has thread-like inner profilings which are formed in a manner complementary to outer windings of the thread-pitch cable.

11. The thread-pitch cable as claimed in claim 8, wherein the sheet-metal bending part is of plate-like form and is folded around the thread-pitch cable such that two tab portions in areal abutment with one another are produced laterally next to the thread-pitch cable.

12. The thread-pitch cable as claimed in claim 8, wherein the sheet-metal bending part is wrapped in a form-fitting manner around outer windings of the thread-pitch cable by cold-forming, or a cold-forming squeezing process, so as to form receiving slots or inner profilings.

13. The thread-pitch cable as claimed in claim 8, wherein the sheet-metal bending part is surrounded, or is encapsulated, by a plastic body which can be connected in a form-fitting manner to the drive slide.

14. The thread-pitch cable as claimed in claim 8, wherein the sheet-metal bending part has a connection portion which is spaced apart laterally from the thread-pitch cable and which can be connected in a form-fitting manner to the drive slide.
